(19) United States
(12) Patent Application Publication
(10) Pub. No.: US 2002/0053868 A1
(43) Pub. Date: May 9, 2002

(54) FLUORESCENT LAMP

(76) Inventors: MASANORI SHIMIZU, KYOTANABE-SHI (JP); YOKO SHIMOMURA, IKOMA-SHI (JP); YOSHINORI TANABE, HIRAKATA-SHI (JP)

Correspondence Address: RATNER & PRESTIA, ONE WESTLAKES BERWYN, SUITE 301, PO BOX 980, VALLEY FORGE, PA, 194820980

(21) Appl. No.: 09/456,941

(22) Filed: Dec. 7, 1999

(30) Foreign Application Priority Data
Dec. 7, 1998 (JP) HEI 10-346,226

(51) Int. Cl. H01J 63/04

(52) U.S. Cl. 313/486

(57) ABSTRACT

A two-wavelength band light emitting type fluorescent lamp the main light emission of which is obtained by fluorescent substances in which the ranges of the wavelength peak of light emission are located from 470 to 540 nm and from 600 to 650 nm.

The fluorescent lamp has light colors located within a range where y is not larger than −0.43x+0.60 and x is not smaller than 0.16 on xy chromaticity coordinates and having Duv not lower than 5.

The fluorescent lamp can perform a categorical identification of colors including at least red, green, blue, yellow and white for surface colors of an object to be illuminated.

### BACKGROUND OF THE INVENTION

1. Field of the Invention

The present invention relates to a fluorescent lamp which can ensure a color reproducibility at the minimum to classify and identify the surface colors such as red, green, blue, yellow and white which are basic colors for a categorical decision of colors by human beings and realize a highly efficient illumination light source with an excellent visual brightness under a scotopic vision and a mesopic vision.

2. Related Art of the Invention

In a conventional fluorescent lamp, the design of spectral characteristics thereof has been carried out by evaluating the exactness of a subtle color reproduction for a standard light source such as black body radiation or combined daylight using an average color rendering evaluation value Ra.

On the contrary, the inventors of the present invention put to practical use and develop the color reproduction characteristics that human beings roughly identify colors, that is to say, a categorical color perception to evaluate the exactness of the color reproduction, so that they proposed a light source the design of spectral characteristics of which is optimized (see PCT/JP96/02618: Light Source, International Patent Laid-Open No. WO97/11480).

This light source realizes a highly efficient light source by mainly taking a visual efficiency under a photopic vision into consideration, while maintaining the color reproducibility for classifying and identifying (categorical color perception) the surface colors including red, green, blue, yellow and white which are basic colors for the categorical decision of colors of human beings by concentrating emitted light mainly to the wavelength bands of green and red.

This light source will be called a “highly efficient light source,” hereinafter.

Since such a highly efficient light source gives priority to the light emitting efficiency of the light source while it satisfies a minimum appearance of color, it is mainly employed for an exterior illumination. The above-described light source is used for the exterior illumination, because the high quality appearance of colors is not needed in the exterior illumination as in an interior lighting and the light emitting efficiency of the light source is preferentially taken into account.

In the exterior illumination such as a road illumination, a street illumination, etc. there is frequently carried out an illumination with illuminance relatively lower than that of the interior lighting.

Further, it has been known that the visual cells of the eyes of human beings include cones and rods, the cones operate under the state of a photopic vision with high illuminance, the rods operate under the state of a scotopic vision with low illuminance and both the cones and the rods operate under the state of a mesopic vision with intermediate illuminance.

The above-mentioned conventional highly efficient light source mainly investigates a visibility or spectral luminous efficacy in the photopic vision with relatively high intensity of illumination or illuminance and is designed to realize such a spectral distribution as to improve the light emitting efficiency relative to a spectral luminous efficiency function V(λ) in a standard photopic vision on the assumption of the state of a photopic vision in which the cones operate.

On the contrary, however, since places to which the highly efficient light source is generally applied are those which are designed to be illuminated with relatively low illuminance under the state of a scotopic vision in which the rods operate or the state of a mesopic vision or dim light, a sufficient visible brightness cannot be undesirably obtained.

### SUMMARY OF THE INVENTION

Accordingly, it is an object of the present invention to overcome the above-described problem and to provide a fluorescent lamp of a highly efficient light source in which a visible brightness in a scotopic vision and in a mesopic vision is improved.

The fluorescent lamp according to the present invention is characterized in that the visible brightness in the scotopic vision and in the mesopic vision is improved by making the light emitting band of green of two main light emitting bands of the highly efficient light source more pertinent.

According to the present invention, the spectral characteristics of the highly efficient light source are designed by setting importance on a state with relatively low illuminance under consideration of the influence of rods. Therefore, the visible brightness in the state of a mesopic vision and in the state of a scotopic vision can be improved.

### BRIEF DESCRIPTION OF THE DRAWINGS

FIG. 1 is a diagram showing the spectral distribution of a fluorescent lamp;

FIG. 2 is a diagram showing relative spectral luminous efficiency of a scotopic vision and a photopic vision;

FIG. 3 is a diagram showing the spectral characteristics relative spectral luminous efficiency in a mesopic vision;

FIG. 4 is a diagram showing the comparison of basic spectral sensitivity between rods and cones;

FIG. 5 is a diagram showing the relation between a light vision area and a color vision area;

FIG. 6 is a diagram showing the range of a fluorescent lamp according to one embodiment of the present invention in the xy chromaticity coordinates; and

FIG. 7 is a diagram showing the positions of unique colors on the xy chromaticity coordinates.

[Description of Symbols]

1 LAP

2 YOX

3 SCA

4 SAE

5 CMZ

6 CBM

7 BAM

### PREFERRED EMBODIMENT OF THE INVENTION

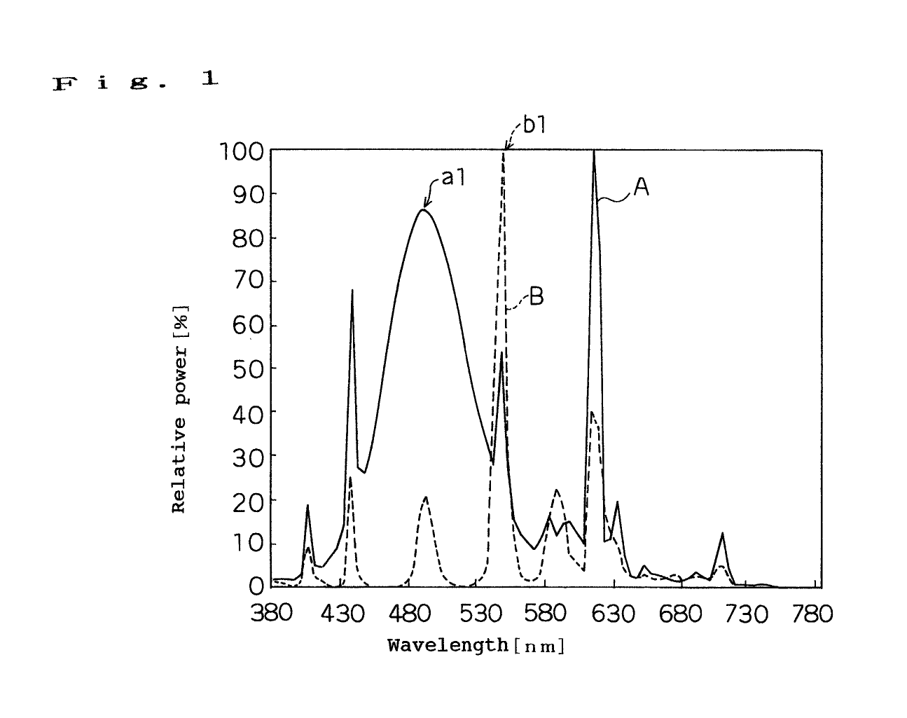

Now, an embodiment of the present invention will be described below by referring to FIGS. 1 to 7.

The fluorescent lamp according to this embodiment of the present invention is different from the conventional fluorescent lamp of the highly efficient light source having the spectral characteristics based on the spectral luminous efficacy in the photopic vision, about such viewpoint that the light emitting band of green of main light emitting bands is made more appropriate, in order to improve the visible brightness in the scotopic vision and in the mesopic vision.

The fluorescent lamp according to this embodiment will be described in more detail hereinafter.

FIG. 1 shows the representative spectral distribution of the fluorescent lamp according to the present invention.

A solid line A indicates the spectral distribution of the fluorescent lamp according to the present invention. A broken line B indicates the spectral distribution of the conventional fluorescent lamp using the highly efficient light source.

The light emitting bands of the conventional highly efficient light source are concentrated to a red light wavelength band in the range of 600 to 650 nm and a green light wavelength band in the range of 530 to 580 nm.

On the other hand, in the fluorescent lamp according to this embodiment of the present invention, while the red light emitting band of the two main light emitting bands is substantially equal to that of the conventional fluorescent lamp, a peak a1 shown by the solid line A is shifted nearer to a short wavelength side than a peak b1 shown by the broken line B so that the green light emitting band comes nearer to a bluish green wavelength band in the short wavelength side. Therefore, the light emitting bands of the fluorescent lamp according to this embodiment of the invention are concentrated to the range of 470 to 540 nm and the range of 600 to 650 nm.

The two-wavelength band light emitting type light source of the fluorescent lamp according to the present invention means that it includes a larger quantity of the radiant fluxes of fluorescent substances whose wavelength peaks of emitted light range from (1) 470 to 540 nm and from 600 to 650 nm or (2) 480 to 530 nm and from 600 to 650 nm, among the radiant fluxes of fluorescent substances included in all bands of visible wavelength in the range of 380 to 780 nm, than that of a three-wavelength band light emitting type light source having equivalent correlated color temperature.

According to the fluorescent lamp with the above mentioned constitution, the visible brightness in the scotopic vision and in the mesopic vision can be improved more than the conventional fluorescent lamp.

This advantage can be obtained because of reasons mentioned below.

The response characteristic of the brightness of light differs depending on spectrum, which is called a spectral luminous efficiency or a spectral luminous efficiency function. Generally, the brightness of illumination is evaluated by a standard spectral luminous efficiency function in a photopic vision (referred to as “V(λ),” hereinafter) and a standard spectral luminous efficiency function in a scotopic vision (referred to as “V′(λ),” hereinafter) determined by the International Commision on Illumination (referred to as “CIE,” hereinafter).

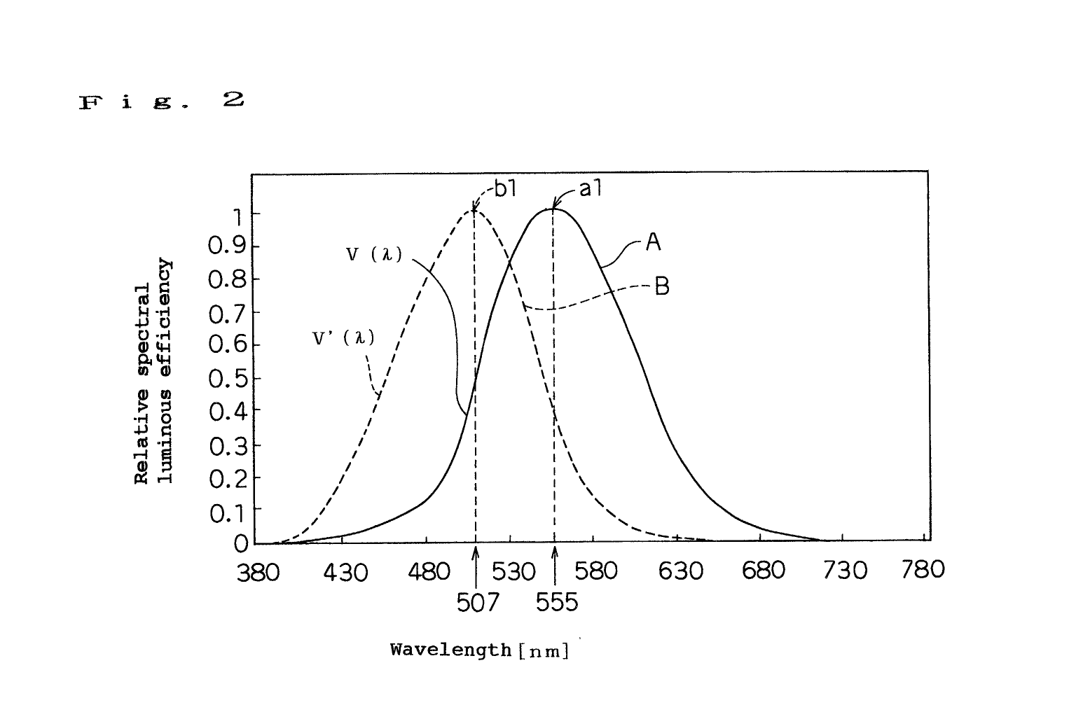

FIG. 2 shows the spectral luminous efficiency functions in the scotopic vision and in the photopic vision.

A solid line A indicates V(λ), and a broken line B indicates V′(λ), respectively. Assuming that a maximum peak is 1, respective peaks are shown relatively to each other.

V(λ) represents a state in which the eyes of human beings grow accustomed to a bright place, in other words, the brightness sensitivity characteristic of the cones of visual cells in a photopic vision. It is known that the center a1 of the sensitivity is located in the wavelength of 555 nm. An ordinary illumination light source is evaluated by a spectral characteristic efficiency relative to V(λ).

V′(λ) represents a state in which the eyes of human beings are used to a dark place, in other words, the brightness sensitivity characteristic of the rods of visual cells in a scotopic vision. It is apparent that the center b1 of the sensitivity is located in the wavelength of 507 nm.

It is said that the mesopic vision in a state of intermediate brightness between the photopic vision and the scotopic vision has an intermediate spectral luminous efficiency characteristic therebetween. The spectral luminous efficiency characteristic of a photopic vision, a scotopic vision or a mesopic vision changes depending on the adapted condition of eyes to the brightness of circumstances.

Therefore, as illustrated in FIG. 2, the spectral sensitivity of a blue or bluish green band under a state of a scotopic vision or a mesopic vision is higher than that under a state of a photopic vision.

Accordingly, the spectrum of the blue or bluish green band is added to the highly efficient light source which is frequently employed mainly in a dark place with low design illuminance, that is to say, under a state of a light scotopic vision or under a state of a mesopic vision, which is different from the conventional illumination light source assuming an efficiency in the photopic vision, so that a visible and effective brightness can be increased.

Now, there will be shown a correction example of the spectral response characteristic for the brightness of light in an intermediate area under a mesopic vision between V(λ) and V′(λ).

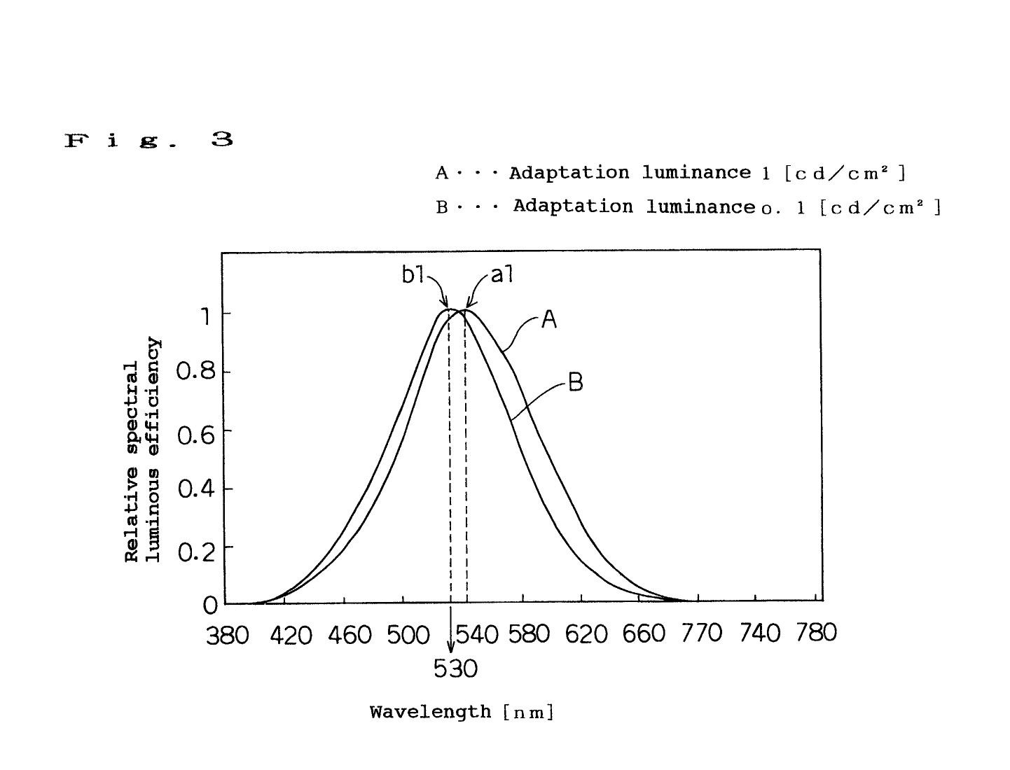

FIG. 3 shows the spectral characteristic of a spectral luminous efficiency in a mesopic vision provisionally set by the Illuminating Engineering Institute of Japan; committee of research and examination of illuminating technology of a mesopic vision level; a report of examination and research of illuminating technology of a mesopic vision level: 1987). A solid line A indicates the spectral characteristic of the spectral luminous efficiency in a mesopic vision with adaptation luminance of 1 [cd/m²] (corresponding to the place of illumination of about 10 [lx]). A solid line B indicates the spectral characteristic of the spectral luminous efficiency in a mesopic vision with adaptation luminance of 0.1 [cd/m²] (corresponding to the place of illumination of about 1 [lx]).

The peak a1 of the spectral luminous efficacy is located in the wavelength of 540 nm in the case of the adaptation luminance of 1 [cd/m²]. The peak b1 of the spectral luminous efficacy is located in the wavelength of 530 nm in the case of the adaptation luminance of 0.1 cd/m². It can be understood from the above fact that the peak of the brightness sensitivity characteristic shifts nearer to the short wavelength side, as the adaptation luminance is lowered.

Although the above described results reflect well the actual condition of the brightness of the light source relative to V(λ) under the illumination with low illuminance, the spectral response characteristic of the brightness of light except V(λ) is situated at a position of the auxiliary luminous quantity of brightness, and therefore, it is not reflected in the evaluation and development of the brightness of an ordinary lamp.

Further, in the conventional highly efficient light source, there has been carried out an investigation to enhance an efficiency relative to V(λ). On the other hand, according to the present invention, the visible and effective brightness is increased relative to V′(λ) so as to carry out an improvement meeting the actual condition of the highly efficient light source which is frequently employed with relatively low illuminance.

An ordinary illumination light source aims at stimulating three kinds of cones including the S cone, the M cone and the L cone which operate in the photopic vision.

The highly efficient light source has a similar purpose of initially satisfying the spectral luminous efficiency V(λ) in the photopic vision with good efficiency. Therefore, the light emission is concentrated mainly to green and red bands to stimulate two kinds of cones including the M cone and the L cone and to mainly excite the r-g opponent color response system of a visual sense. Thus, while a sufficient color perception is obtained as required, a highly efficient light source is realized.

In the highly efficient light source mentioned above, since the peak a1 of the spectral luminous efficiency V(λ) in the photopic vision is set to the green wavelength of 555 nm as described above, the emitted light focussed on the green band can efficiently raise the brightness of light of the highly efficient light source in the photopic vision.

On the other hand, however, since the peak b1 of the spectral luminous efficiency V′(λ) in the scotopic vision is located in the bluish green wavelength of 507 nm, it is necessary to shift the center of the wavelength of emitted light nearer to the short wavelength side in order to efficiently enhance the brightness in an illuminance level in which the rods are more activated.

Therefore, in this embodiment, the peak of wavelength of one light emission of the main light emission of the fluorescent lamp for a categorical color perception which employs the highly efficient light source is set to range from 470 to 540 nm.

This range is a wavelength band in which the rods can be stimulated with high efficiency and the spectral luminous efficiency of V′(λ) reaches a peak ratio not lower than 65% within the range of wavelength of 470 to 540 nm. Further, the spectral luminous efficiency of V′(λ) reaches a peak ratio not lower than 80% within the range of wavelength of 480 to 530 nm, hence the rods can be further stimulated with high efficiency.

As described above, the more the light emitting band is restricted by locating the peak wavelength of 507 nm of V′(λ) at its center, the more the efficiency of stimulation to the rods can be raised. This can be arbitrarily designed.

Further, 540 nm of wavelength also indicates the peak of the spectral luminous efficiency in the mesopic vision in a side near to that in the photopic vision. Therefore, if the center of the wavelength of light emission is further brought nearer to a long wavelength side, it will be difficult to discriminate the conventional optimization of the efficiency of brightness of V(λ) in the photopic vision from the peak of the spectral luminous efficacy.

Still further, when the peak wavelength of the light emitting band is lower than 470 nm, the spectral luminous efficiency of V′(λ) becomes a peak ratio not higher than 65% so that the rods cannot be stimulated with high efficiency.

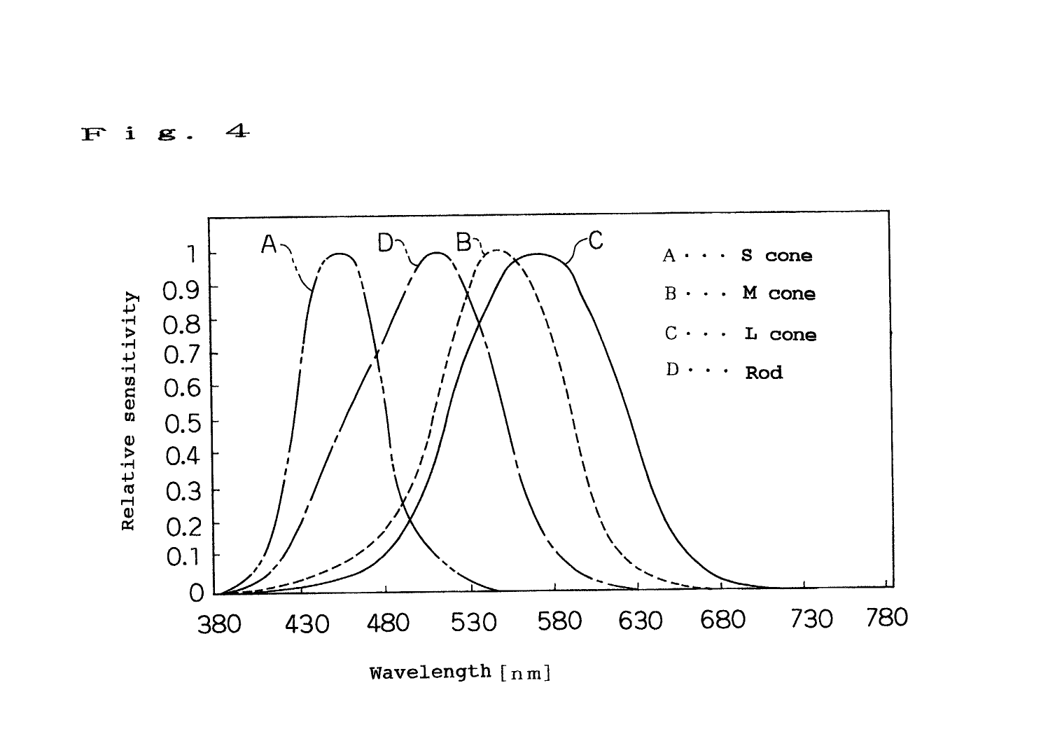

FIG. 4 shows a comparison in basic spectral sensitivity between the rods and the three kinds of cones including the S cone, the M cone and the L cone. A curve A, a curve B and a curve C respectively show the Smith-Pokorny basic spectral sensitivity of the S cone, the M cone and the L cone. A curve D shows the basic spectral sensitivity of rods. These curves are compared relative to one another, by assuming that their peaks are respectively 1.

V(λ) shown in FIG. 2 reflects the combination of the basic spectral sensitivity characteristics of three kinds of cones of visual cells including the S cone having the peak of its spectral luminous efficacy in the short wavelength side as shown by the curve A, the L cone having the peak of its spectral luminous efficacy in the long wavelength side as shown by the curve C and the M cone having the peak of its spectral luminous efficacy between the S cone and the L cone as shown by the curve B.

Although these cones are relatively to the rods in respect of the sensitivity to light, the existence of three kinds of cones enables colors to be identified. On the other hand, while the rods are superior relatively to the cones in respect of the sensitivity to light, they cannot identify colors, because there exist rods of only one type.

Here, as apparent from FIG. 4, the rods shown by the curve D which operate in the mesopic vision and in the scotopic vision have the peak of its spectral sensitivity between the S cone shown by the curve A and the M cone shown by the curve B.

Accordingly, as the illuminance level is gradually lowered from the mesopic vision to the scotopic vision, the reaction of the rods which cannot identify colors increases relative to the reactions of the S cone associated with the appearance of blue color and the M cone associated with the appearance of green.

As a consequence, while colors from blue to green look bright under a visual environment of a low illuminance level, it is difficult to identify the hues thereof.

On the contrary, in the appearance of red, the light vision area is near to the color vision area. Therefore, while the lightness of the tints of colors included in a range of yellow to red is low with illuminance level thereof decreased so that colors included in the range of yellow to red look dark, the sense of color remains as long as the light can be felt.

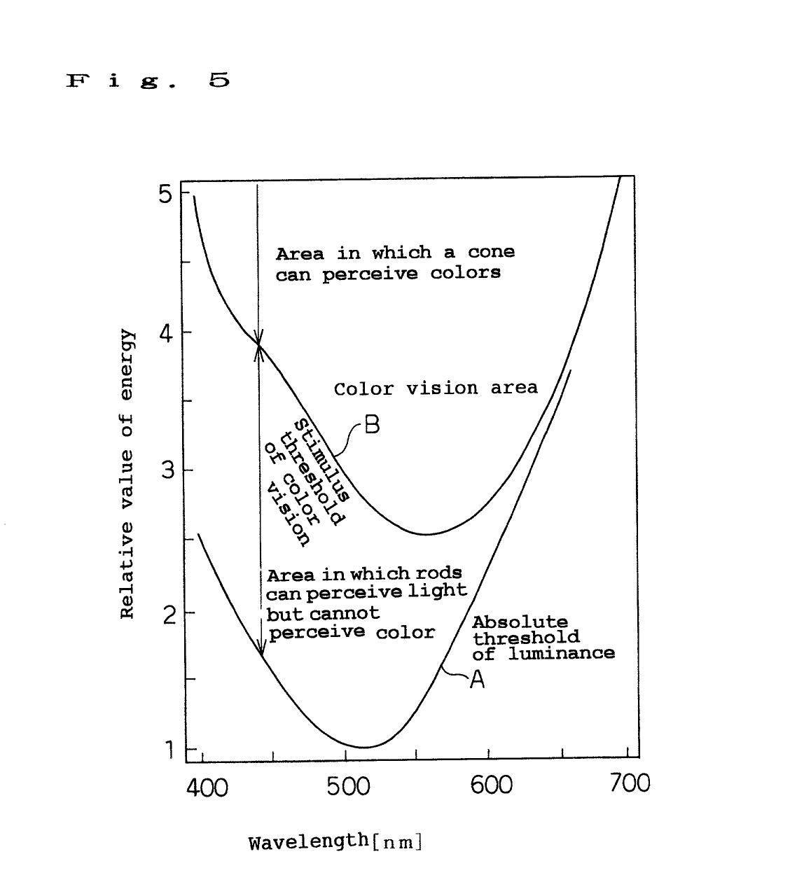

The above described matter can be recognized from the relation between the light vision area and the color vision area shown in FIG. 5.

Referring to FIG. 5, a solid line A indicates a light vision area for each wavelength and a solid line B indicates a color vision area. An area above the light vision area shown by the solid line A and below the color vision area shown by the solid line B is an area in which the rods are active so that lights can be perceived, but colors cannot be seen. An area above the color vision area shown by the solid line B designates an area in which the cones active so that colors can be perceived.

Since the light vision area comes near to the color vision area and is substantially identical with the color vision area under the wavelength not shorter than 600 nm, if the light of a red spectrum is seen, the perception of a red color can be almost always obtained.

On the other hand, since a space between the light vision area and the color vision area is broad in the case of the light of a blue or green spectrum, there is more widely spread an area where even when the light can be perceived, the tint thereof cannot be perceived.

This phenomenon occurs, because the rods which operate but cannot perceive colors even under relatively low illuminance have the peak of the spectral sensitivity between the S cone and the M cone, as illustrated in FIG. 4.

Therefore, in order to ensure the appearance of categorical colors with high efficiency at an illuminance as low as possible, it has been found by us that the red wavelength band of 600 nm or more may be added to the bluish green wavelength band of 470 to 540 nm with high spectral luminous efficacy under a low illuminance environment.

In this case, since the excessive increase of the band in the long wavelength side causes the visibility or the spectral luminous efficacy relative to V′(λ) to be deteriorated, the addition of the light in the long wavelength side not shorter than 650 nm to which the rods substantially have no sensitivity is meaningless.

In the long wavelength side of 650 nm or longer, the sensitivity of the rods is not higher than 1/100 in terms of a peak ratio relative to V′(λ), so that the rods scarcely have sensitivity to the long wavelength side.

Since the spectral response characteristics of both the cones and the rods have gentle extents, when spectra for mainly stimulating the rods are increased, as a result, the S cone and the M cone are also stimulated to some extent. Therefore, a high quality color reproduction cannot be achieved, however, the categorical color identification of colors ranging from blue to green can be realized.

As apparent from the above description, it is desired that the bluish green spectrum band as a first main light emitting band is more increased and the minimum light emission of a red spectrum band as a second main light emitting band is added thereto, from the viewpoint that at least the categorical color identification of red, green, blue, yellow and white colors of the surface colors of an object to be illuminated can be achieved, while the spectral luminous efficacy in the scotopic vision and in the mesopic vision is improved.

Further, in order to increase the rate of stimulation to the rods, in case the correlated color temperature serving as the index of the light color of an ordinary light source is extensively employed as an index, it is necessary to set the correlated color temperature of the light color of a lamp to a high value or to set the chromaticity of the light color of the lamp to a range described below in xy chromaticity coordinates.

Turning to the correlated color temperature of the light color of the lamp, it has been experientially realized that the light source having higher correlated color temperature in the general illumination light sources looks brighter even under the same illuminance environment. Therefore, also according to the present invention, it is possible to consider that the light source of higher correlated color temperature emits more light of the blue or bluish green band, so that the rods are more stimulated.

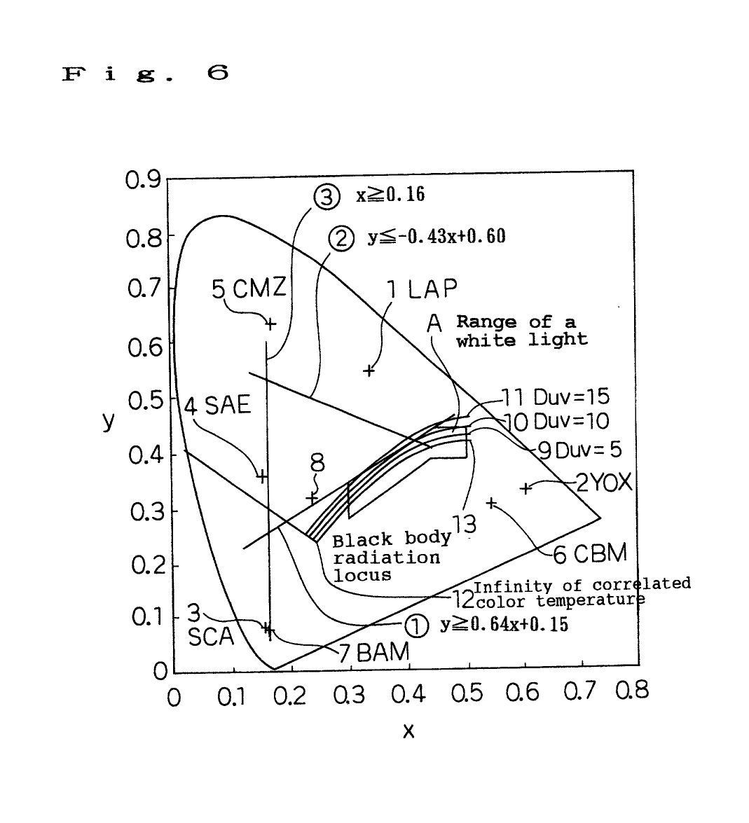

FIG. 6 shows the range of the fluorescent lamp using the highly efficient light source according to the present invention on the xy chromaticity coordinates.

In the fluorescent lamp according to the present invention, it is necessary that the light colors of the highly efficient light source are included in an area surrounded by the following Equations (1) to (3) on the xy chromaticity coordinates.

y≧0.64x+0.15 Equation (1)

y≦−0.43x+0.60 Equation (2)

x≧0.16 Equation (3)

Equal signs may not be used in the respective Equations.

Further, a range shown by an area A designates the range of a white light in the CIE Draft Standard 004.2: Colors of signal lights (1996).

According to the present invention, Duv is located in the area of light colors nearer to a plus side than the above described area A, different from the conventional case.

Duv is a unit indicating the deviation from a black body radiation locus on uv chromaticity coordinates (CIE 1960: color difference on the uv chromaticity coordinates multiplied by 1000). Since the categorical color perception of the basic colors can be carried out with high efficiency in a range with bluish green Duv of which is not lower than 0 increased, Duv assumes plus values in the fluorescent lamp according to the present invention, as long as the categorical color representation of the basic colors can be maintained. This is because of the fact that the larger the values of Duv becomes, the higher the efficiency of the lamp becomes.

The Equation (1) designates limit for the white colored lamp to turn to greenish color on the basis of the above described CIE. Thus, as the values of y increase, the higher efficiency can be obtained than the conventional light source.

In FIG. 6, a curve 13 designates a black body radiation locus, that is to say, a line of Duv=0. Curves 9, 10 and 11 indicate respectively lines of Duv=5, 10 and 15.

A reference numeral 12 designates a line showing the infinity of the correlated color temperature of each Duv and indicates a lower limit when the present invention is expressed by the correlated color temperature and Duv.

In case Duv which has not been employed in the conventional illumination light source specifies a plus range, the conventional technique can be explained on the basis of the standard of the IEC (International Electrotechnical Commission) as an international standard concerning the chromaticity divisions of the illumination light source.

Still further, there is known the standard Z9112-1990 of the chromaticity divisions of fluorescent lamps determined by the JIS (Japanese Industrial Standard) in Japan.

While the light colors of the light source should depend on the standard of each country so that it is difficult to have an international agreement thereon, they are fundamentally specified by the following two methods.

One of the methods is a method like the IEC that a central point is determined in the vicinity of the black body radiation locus so that the light colors are determined with an allowance thereof. The other of the methods is a method like the JIS that limiting lines are specified on the upper and lower parts in the vicinity of the black body radiation locus to obtain a range of tolerance therebetween. Particularly, the conventional lamp has been developed under a consideration that Duv is not greatly deviated from the black body radiation locus (Duv=0) from the standpoint of evaluation of the conventional color rendering characteristic.

Here, since the maximum vertical width of Duv of the illumination light source based on the IEC ranges from 7.5 to 9.5 and that of the illumination light source based on the JIS ranges from 10 to 19, the light colors in the IEC range from ±7.5/2 to ±9.5/2, and the light colors in the JIS range from ±10/2 to ±19/2 or so generally by locating Duv=0 at the center. In the illumination light source based on the IEC or a practically used illumination light source, the light colors may be usually included in an area in which Duv is near to 0 up to about 5 in the plus side if possible. Further, in the case of the JIS, the maximum values of Duv indicate the light colors substantially included within a range having the values of Duv not higher than 10 or within a range having the values of Duv not higher than 15, if estimated exaggeratedly.

Since the light emitting efficiency is improved as Duv goes to the plus side from 0, the values of Duv, for example, not lower than 5, not lower than 10, not lower than 15, or exceeding a range of 16 to 25, can be properly selected within a range in which the categorical perception can be attained, at the sacrifice of conscientious reproduction of colors.

Further, since the range of Duv which has been conventionally employed is not fixed depending on the correlated color temperature, Duv has a plus range excluding the ranges of the light colors based on the conventional IEC and the JIS so that the light source of the present invention can obtain the efficiency higher than that of the conventional light source.

In other words, the range of the values of Duv which has been hitherto used can be also changed so as to meet the correlated color temperature. In addition, the range specified by the Equation (1) in the IEC and JIS can be removed.

The range specified by the Equation (2) shows a result of obtaining a point in which the impression of a tint (particularly, yellowish tint) in the light emitting part of the light source with the values of Duv in the plus side begins to decrease on the basis of a subjective evaluation experiment.

The decrease of the yellowish tint desirably has no old-looking impression due to a light emitting lighting equipment which changes to have a yellowish color when the luminous intensity of the light emitting part of the light source is low.

Further, since the decrease of a yellowish tint increases blue which is a complementary color relative thereto, the illumination efficiency in the scotopic vision is improved. Therefore, the restriction of the above Equation (2) is required.

The above described subjective evaluation experiment was carried out in such a way that the lights emitted from the fluorescent lamp were mixed together, on which LAP generally known as a fluorescent substance (its composition is LaPO₄: Ce, Tb) having its light emission peak in a green band, YOX generally known as a fluorescent substance (its composition is Y₂O₃: Eu) having its light emission peak in a red band, SCA generally known as a fluorescent substance (its composition is (Sr, Ca, Ba)₅(PO₄)₃Cl: Eu) having its light emission peak in a blue band and SAE generally known as a fluorescent substance (its composition is Sr₄Al₁₄O₂₆: Eu) having its light emission peak in a bluish green band were applied respectively in the form of a simple substance and a point at which the tints, particularly, a yellowish tint, of the colors of light emission decrease was obtained by an adjusting method.

The positions of the light colors of the fluorescent lamp employing these fluorescent substances respectively in the form of a simple substance are shown on the xy chromaticity coordinates in FIG. 6.

1 shows LAP, 2 shows is YOX, 3 is SCA and 4 shows SAE.

As an example of a fluorescent lamp on which a fluorescent substance other than the above described substances is applied in the form of a simple substance having its emitted light wavelength peak ranging from 470 to 540 nm, CMZ (its composition is Ce (Mg, Zn)Al₁₁O₁₉: Mn) is shown at a point 5.

Further, as an example of a fluorescent lamp on which a fluorescent substance other than the above described substances with its wavelength peak of light emission ranging from 600 to 650 nm is applied in the form of a simple substance, CBM (its composition is (Gd, Ce)Mg B₅O₁₀: Mn) is shown at a point 6.

CMZ or SAE with its wavelength peak of light emission ranging from 470 to 540 nm is mixed with LAP or CBM with its wavelength peak of light emission ranging from 600 to 650 nm, so that the chromaticity range of the present invention can be realized.

Further, a very small amount of fluorescent substances such as SCA shown at the point 3 and BAM shown at a point 7 (its composition is BaMgAl₁₀O₁₇: Eu) which emit spectral lights in the short wavelength side except the fluorescent substances mainly emitting lights is added thereto, hence chromaticity values can be greatly changed with the addition of a minimum sub-light emission. Therefore, the light source having arbitrary chromaticity can be realized while the deterioration of efficiency encountered in V′(λ) is suppressed.

The position of BAM is shown at the point 7 on the chromaticity coordinates shown in FIG. 6.

In SBAT (its composition is (Ba, Sr) MgAl₁₀O₁₇: Eu, Mn) with its wavelength peak of light emission ranging 470 to 540 nm, when the ratio of europium to manganese is changed, the chromaticity can be arbitrarily changed within a range corresponding to an area between SAE at the point 4 and BAM at the point 7, so that a degree of freedom for designing a lamp is enhanced.

The spectral distribution illustrated in FIG. 1 is gained by employing the fluorescent substances of SBAT and YOX at the point 2. The position thereof is shown at a point 8 on the chromaticity coordinates.

Now, fluorescent substances will be exemplified for each range of the wavelength peak of light emission.

As examples of fluorescent substances activated by europium with the wavelength peak of light emission ranging from 470 to 540 nm, there are exemplified Sr₄Al₁₄O₂₅: Eu, 2SrO. 0.84 P₂O₅.0.16 B₂O₃:Eu, (Ba, Ca, Mg)₁₀(PO₄)₆.Cl₂: Eu or the like.

As examples of fluorescent substances activated by europium and manganese, there are exemplified (Ba, Sr) Mg Al₁₀O₁₇:Eu, Mn, BaMg₂Al₁₀O₁₇:Eu,Mn.

As an example of fluorescent substances activated by manganese, there is exemplified Ce (Mg, Zn) Al₁₁O₁₉: Mn.

As an example of fluorescent substances activated by antimony or manganese, or both of them, there is exemplified calcium halophosphate as a fluorescent substance whose composition is expressed by Ca₅(PO₄)₃(F, Cl): Sb, Mn and the rate of antimony to manganese of which is changed. Since manganese as an activator has its light emission peak in a yellowish band and antimony as an activator has its light emission peak in a bluish green band in this fluorescent substance, if the concentration of antimony is increased, the light of the bluish green band will be increased.

Specifically, according to the present invention, Mn may not be included, as claimed in attached claims. In this case, the emission of light having a pale color with a single peak is obtained. Further, this fluorescent substance is employed so that the fluorescent lamp according to the present invention can be manufactured at low cost.

Further, as examples of fluorescent substances with the wavelength peak of light emission located in a range of 600 to 650 nm, there are exemplified fluorescent substances activated by europium such as Y₂O₃:Eu, (YGd)₂O₃:Eu.

Still further, as an example of fluorescent substances activated by manganese, there is exemplified a fluorescent substance such as (Gd, Ce) MgB₅O₁₀: Mn or the like.

Here, the range of x≧0.16 specified by the Equation (3) indicates the tolerance limit of the intensity of a bluish green tint.

3 and 4 shown in FIG. 6 designate the positions of SCA and SAE on the chromaticity diagram when the fluorescent lamp is realized by using the fluorescent substances of SCA and SAE. The above described Equation is constituted by taking a realization into account so that these chromaticity values are not adopted.

Accordingly, when the values of x become excessively small, the monochromaticity of a spectral characteristic spectrum becomes too strong, so that the completely allowable representation of categorical colors can be hardly realized.

Further, when the light emission of these bands is increased, the light emission of the red band is relatively decreased, hence the appearance of red which is employed as a safety color for an important meaning such as the display of a danger is inconveniently deteriorated. Although the range of x≧0.16 is specified in the Equation (3), in order to decrease the monochromaticity and the intensity of a bluish tint, arbitrary values ranging from 0.16 to 0.3 (for instance, 0.2, 0.25 or 0.28 or the like) may be employed, these values may be preferably large from the viewpoint of the appearance of categorical colors. x≧0.16 is equal to a limit for the white colored lamp to shift to a bluish color in the above described CIE Draft Standard 004.2.

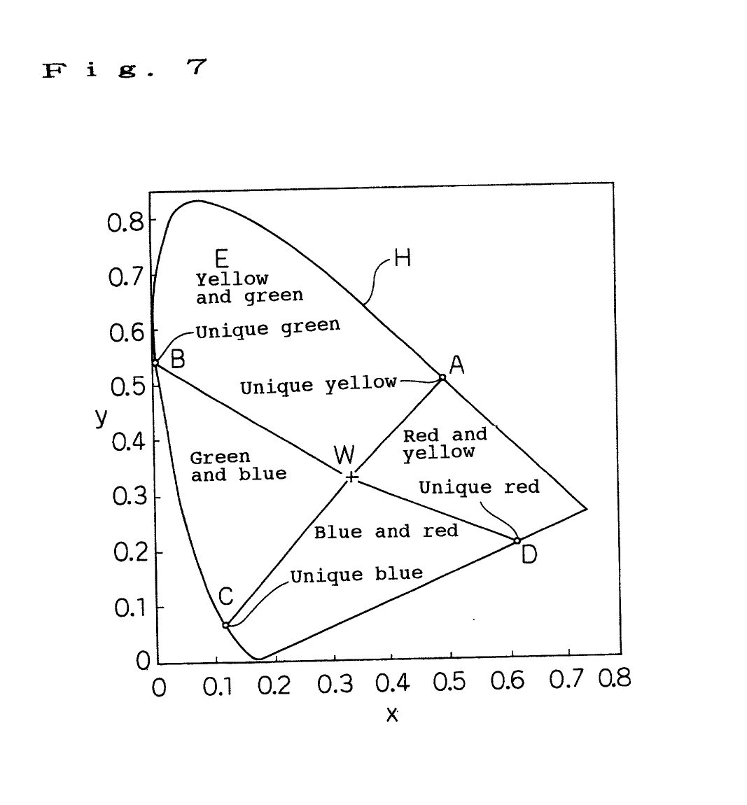

Referring to FIG. 7, the positions of unique colors are shown on a spectrum locus.

A point A shows unique yellow, a point B shows unique green, a point C shows unique blue and a point D shows unique red, respectively. A point W shows equal energy white. A curve H shows a spectrum locus.

The unique colors mean the optical stimulation of wavelength for providing a color sense sensitive to the stimulations of pure red, green, blue and yellow when the single spectrum of the wavelength of light is sampled to observe it. For example, when the light of wavelength of a spectrum located in an area E surrounded by a straight line formed by connecting the point A to the point W, a straight line formed by connecting the point B to the point W and the curve H is observed, a yellowish tint and a greenish tint are both perceived in the light.

Theoretically, the yellowish tint and the greenish tint are perceived in the light colors on the xy chromaticity coordinates surrounded by the unique yellow A, the unique green B and the equal energy white W. As one comes nearer to a spectrum locus on the outer periphery of the configuration of a hanging bell separate from the white color, in other words, the position of a monochromatic color, the above described tins increase.

Further, when the light colors having the same color difference from the white color are compared with each other, the yellowish tint and the bluish tint which are opposite colors on a line formed by connecting the unique green to the white color compete with each other.

When the light source according to the present invention is actually applied to a lighting equipment, the light color which looks yellowish gives an old-looking impression thereto, so that an area nearer to a bluish color than to the line for connecting the unique green to the white color may be preferable.

This line is similar to the line employed for the subjective evaluation experiment. It may be estimated or guessed that the result of the experiment is generated due to such a mechanism as described above and when the rate of stimulation of a bluish color relative to the stimulation of a yellowish color exceeds a prescribed amount.

As stated above, the chromaticy range of the present invention is put into practice, hence the light source can be realized, in which the spectral luminous efficacy relative to V′(λ) is high and the intensity of tints (particularly, yellowish tint) sensitive to the light colors is mitigated.

In this connection, it is desired from the viewpoint of the visual efficiency and the light colors that the range of the light colors is set to a range among the above described ranges which is near to the white color and in which the sense of a yellowish green is offset by the sense of a bluish green.

According to the present invention, since the fluorescent lamp is provided with the constitution of the above described embodiment, the light source with a principal purpose of the high efficiency which has the high visual brightness in the scotopic vision and in the mesopic vision can be realized while maintaining the color reproducibility that the surface colors including red, green, blue, yellow and white can be classified and identified at the minimum. Therefore, the highly efficient illumination can be greatly improved in places where an importance is not attached to the conscientious appearance of colors under low illuminance.

Accordingly, the fluorescent lamp according to the present invention is used both in the state of a scotopic vision and in the state of a mesopic vision under low design illuminance and can be applied to extensive fields such as a traffic lighting, a street lighting, a safety lamp a reserve lamp, the factory lighting of an automated factory, a public lighting in a lonely street, etc. which do not need the accurate representation of the colors, however, attach importance to an energy saving effect or an economical efficiency.

Furthermore, from the viewpoint of manufacture, each of the ranges of the wavelength peaks of two main light emissions can be realized by only one fluorescent substance, and therefore, the fluorescent lamp can be formed with only two fluorescent substances with ease in its manufacture. Other sub-light emission fluorescent substances for adjusting colors may not be included in view of the production of the fluorescent lamp.

As apparent from the above description, according to a first aspect of the present invention, there is provided a two-wavelength band light emitting type fluorescent lamp the main light emission of which is obtained in fluorescent substances in which the ranges of the wavelength peak of light emission are located from 470 to 540 nm and from 600 to 650 nm, wherein the fluorescent lamp has light colors located within a range where y is not larger than −0.43x+0.60 and x is not smaller than 0.16 on xy chromaticity coordinates and having Duv not lower than 5 and can carry out a categorical identification of colors including at least red, green, blue, yellow and white of the surface colors of an object to be illuminated. Therefore, the emitted light is mainly concentrated to the bluish green and red bands to mainly stimulate the rods and one kind of cone such as a L cone, so that the highly efficient light source can be achieved while the rods of a visual sense obtains a sufficient color perception as desired under high illuminance level. Consequently, the visual brightness can be improved in the scotopic vision and in the mesopic vision.

According to a second aspect of the present invention, there is provided a two-wavelength band light emitting type fluorescent lamp the main light emission of which is obtained in fluorescent substances in which the ranges of the wavelength peak of light emission are located from 470 to 540 nm and from 600 to 650 nm, wherein the fluorescent lamp has light colors located within a range where y is not larger than −0.43x+0.60, y is not smaller than 0.64x+0.15 and x is not smaller than 0.16 on xy chromaticity coordinates and can carry out a categorical identification of colors including at least red, green, blue, yellow and white of the surface colors of an object to be illuminated. Accordingly, the visual brightness in the scotopic vision and in the mesopic vision can be enhanced and the rods and the L cone can be stimulated with good efficiency.

According to a third aspect of the present invention, there is provided a two-wavelength band light emitting type fluorescent lamp described in the above first and second aspects, in which the ranges of the wavelength peak of light emission of the fluorescent substances are located from 480 to 530 nm and from 600 to 650 nm. Thus, the effects of the present invention can be more improved.

According to a fourth aspect of the present invention, there is provided a fluorescent lamp described in any of the above first, the second the third aspects in which the fluorescent substance whose wavelength peak of light emission ranges from 470 to 540 nm is a fluorescent substance activated by any of europium, antimony, manganese, europium and manganese, and antimony and manganese, and the fluorescent substance whose wavelength peak of light emission ranges from 600 to 650 nm is a fluorescent substance activated by any of europium, manganese and cerium and manganese. Thus, above described fluorescent substances may be respectively preferably employed.

According to a fifth aspect of the present invention, there is provided a fluorescent lamp described in the above fourth aspect in which the substance activated by antimony and manganese is a fluorescent substance composed of calcium halo-phosphate. Accordingly, the fluorescent lamp according to the present invention can be manufactured at low cost.

According to a sixth aspect of the present invention, there is provided a fluorescent lamp described in the fourth aspect in which the composition of the fluorescent substance whose wavelength peak of emitted light ranges from 470 to 540 nm may be any one selected from (Ba,Sr)MgAl₁₀O₁₇:Eu,Mn, BaMgAl₁₀O₁₇:Eu,Mn, Sr₄Al₁₄O₂₆,:Eu, Ce(Mg,Zn) Al₁₁O_{19:}Mn, 2SrO. 0.84P₂O₅. 0.16 B₂O₃:Eu or (Ba,Ca,Mg)₁₀(PO₄)₆.Cl₂:Eu.

According to a seventh aspect of the present invention, there is provided a fluorescent lamp described in the above fourth aspect in which composition of the fluorescent substance whose wavelength peak of emitted light ranges from 600 to 650 nm may be preferably any one selected from Y₂O₃:Eu, (YGd)₂O₃:Eu or (Gd,Ce)MgB₅O₁₀:Mn.

What is claimed is:

1. A two-wavelength band light emitting type fluorescent lamp a main light emission of which is obtained by fluorescent substances in which ranges of wavelength peak of light emission are located from 470 to 540 nm and from 600 to 650 nm,
wherein the fluorescent lamp has light colors located within a range where y is not larger than −0.43x+0.60 and x is not smaller than 0.16 on xy chromaticity coordinates and having Duv not lower than 5, and
a categorical identification of colors including at least red, green, blue, yellow and white can be carried out for a surface color of an object to be illuminated.

2. A two-wavelength band light emitting type fluorescent lamp a main light emission of which is obtained by fluorescent substances in which the ranges of a wavelength peak of light emission are located from 470 to 540 nm and from 600 to 650 nm,
wherein the fluorescent lamp has light colors located within a range where y is not larger than −0.43x+0.60, y is not smaller than 0.64x+0.15 and x is not smaller than 0.16 on xy chromaticity coordinates and
a categorical identification of colors including at least red, green, blue, yellow and white can be carried out for a surface color of an object to be illuminated.

3. The two-wavelength band light emitting type fluorescent lamp according to claim 1, wherein the ranges of the wavelength peak of light emission of said fluorescent substances are located from 480 to 530 nm and from 600 to 650 nm.

4. The two-wavelength band light emitting type fluorescent lamp according to claim 2, wherein the ranges of the wavelength peak of light emission of said fluorescent substances are located from 480 to 530 nm and from 600 to 650 nm.

5. A fluorescent lamp according to claim 1, wherein the fluorescent substance whose wavelength peak of light emission ranges from 470 to 540 nm is a fluorescent substance activated by any one of (1) europium, (2) antimony, (3) manganese, (3) europium and manganese, and (4) antimony and manganese, and the fluorescent substance whose wavelength peak of light emission ranges from 600 to 650 nm is a fluorescent substance activated by any one of (1) europium, (2) manganese and (3) cerium and manganese.

6. A fluorescent lamp according to claim 2, wherein the fluorescent substance whose wavelength peak of light emission ranges from 470 to 540 nm is a fluorescent substance activated by any one of (1) europium, (2) antimony, (3) manganese, (3) europium and manganese, and (4) antimony and manganese, and the fluorescent substance whose wavelength peak of light emission ranges from 600 to 650 nm is a fluorescent substance activated by any one of (1) europium, (2) manganese and (3) cerium and manganese.

7. A fluorescent lamp according to claim 3, wherein the fluorescent substance whose wavelength peak of light emission ranges from 470 to 540 nm is a fluorescent substance activated by any one of (1) europium, (2) antimony, (3) manganese, (3) europium and manganese, and (4) antimony and manganese, and the fluorescent substance whose wavelength peak of light emission ranges from 600 to 650 nm is a fluorescent substance activated by any one of (1) europium, (2) manganese and (3) cerium and manganese.

8. A fluorescent lamp according to claim 4, wherein the fluorescent substance whose wavelength peak of light emission ranges from 470 to 540 nm is a fluorescent substance activated by any one of (1) europium, (2) antimony, (3) manganese, (3) europium and manganese, and (4) antimony and manganese, and the fluorescent substance whose wavelength peak of light emission ranges from 600 to 650 nm is a fluorescent substance activated by any one of (1) europium, (2) manganese and (3) cerium and manganese.

9. The fluorescent lamp according to claim 5, wherein
the fluorescent substance activated by antimony and manganese is a fluorescent substance composed of calcium halophosphate.

10. The fluorescent lamp according to claim 6, wherein
the fluorescent substance activated by antimony and manganese is a fluorescent substance composed of calcium halophosphate.

11. The fluorescent lamp according to claim 7, wherein
the fluorescent substance activated by antimony and manganese is a fluorescent substance composed of calcium halophosphate.

12. The fluorescent lamp according to claim 8, wherein
the fluorescent substance activated by antimony and manganese is a fluorescent substance composed of calcium halophosphate.

13. The fluorescent lamp according to claim 5, wherein
composition of the fluorescent substance whose wavelength peak of emitted light ranges from 470 to 540 nm is (Ba,Sr)MgAl₁₀O₁₇:Eu,Mn, or BaMgAl₁₀O₁₇:Eu,Mn, or Sr₄Al₁₄O₂₅:Eu, or Ce(Mg,Zn)Al₁₁O₁₉:Mn, or 2SrO.0.84P₂O₅.0.16 B₂O₃:Eu or (Ba,Ca,Mg)₁₀(PO₄)₆.Cl₂:Eu.

14. The fluorescent lamp according to claim 6, wherein
composition of the fluorescent substance whose wavelength peak of emitted light ranges from 470 to 540 nm is (Ba,Sr)MgAl₁₀O₁₇:Eu,Mn, or BaMgAl₁₀O₁₇:Eu,Mn, or Sr₄Al₁₄O₂₅:Eu, or Ce(Mg,Zn)Al₁₁O₁₉:Mn, or 2SrO.0.84P₂O₅.0.16 B₂O₃:Eu or (Ba,Ca,Mg)₁₀(PO₄)₆.Cl₂:Eu.

15. The fluorescent lamp according to claim 7, wherein
composition of the fluorescent substance whose wavelength peak of emitted light ranges from 470 to 540 nm is (Ba,Sr)MgAl₁₀O₁₇:Eu,Mn, or BaMgAl₁₀O₁₇:Eu,Mn, or Sr₄Al₁₄O₂₅:Eu, or Ce(Mg,Zn)Al₁₁O₁₉:Mn, or 2SrO.0.84P₂O₅.0.16 B₂O₃:Eu or (Ba,Ca,Mg)₁₀(PO₄)₆.Cl₂:Eu.

16. The fluorescent lamp according to claim 8, wherein
composition of the fluorescent substance whose wavelength peak of emitted light ranges from 470 to 540 nm is (Ba,Sr)MgAl₁₀O₁₇:Eu,Mn, or BaMgAl₁₀O₁₇:Eu,Mn, or Sr₄Al₁₄O₂₅:Eu, or Ce(Mg,Zn)Al₁₁O₁₉:Mn, or 2SrO.0.84P₂O₅.0.16 B₂O₃:Eu or (Ba,Ca,Mg)₁₀(PO₄)₆.Cl₂:Eu.

17. The fluorescent lamp according to claim 5, wherein
composition of the fluorescent substance whose wavelength peak of emitted light ranges from 600 to 650 nm is Y₂O₃:Eu, or (YGd)₂O₃:Eu or (Gd,Ce)MgB₅O₁₀:Mn.

18. The fluorescent lamp according to claim 6, wherein
composition of the fluorescent substance whose wavelength peak of emitted light ranges from 600 to 650 nm is Y₂O₃:Eu, or (YGd)₂O₃:Eu or (Gd,Ce)MgB₅O₁₀:Mn.

19. The fluorescent lamp according to claim 7, wherein
composition of the fluorescent substance whose wavelength peak of emitted light ranges from 600 to 650 nm is Y₂O₃:Eu, or (YGd)₂O₃:Eu or (Gd,Ce)MgB₅O₁₀:Mn.

20. The fluorescent lamp according to claim 8, wherein
composition of the fluorescent substance whose wavelength peak of emitted light ranges from 600 to 650 nm is Y₂O₃:Eu, or (YGd)₂O₃:Eu or (Gd,Ce)MgB₅O₁₀:Mn.
